(19) United States
(12) Patent Application Publication
(10) Pub. No.: US 2026/0086890 A1
(43) Pub. Date: Mar. 26, 2026

(54) METHOD AND DEVICE FOR IMPROVING APPLICATION PROGRAMMING INTERFACE (API) TRACE REPLAY WITH SEEK FUNCTIONALITY

(71) Applicant: Samsung Electronics Co., Ltd., Gyeonggi-do (KR)

(72) Inventors: Chris Robert STEINBERG II, Austin, TX (US); Gabriel DAGANI, Austin, TX (US)

(21) Appl. No.: 19/016,760

(22) Filed: Jan. 10, 2025

Related U.S. Application Data
(60) Provisional application No. 63/698,306, filed on Sep. 24, 2024.

(51) Int. Cl. G06F 9/54

(52) U.S. Cl. CPC G06F 9/543

(57) ABSTRACT

A method and device are provided in which a processor generates an application programming interface (API) capture file by recording commands provided from a central processing unit (CPU) to an accelerator. The API capture file includes asset data and a first set of frames having the commands. The processor determines delta changes generated by one or more frames in the first set of frames. The processor generates a capture index file including a second set of frames. Each frame of the second set of frames includes a delta change generated by a corresponding frame of the one or more frames in the first set of frames.

### CROSS-REFERENCE TO RELATED APPLICATION

This application claims the priority benefit under 35 U.S.C. § 119(e) of U.S. Provisional Application No. 63/698,306, filed on Sep. 24, 2024, the disclosure of which is incorporated by reference in its entirety as if fully set forth herein.

### TECHNICAL FIELD

The disclosure generally relates to application programming interfaces (APIs). More particularly, the subject matter disclosed herein relates to improvements to API captured command stream replay.

### SUMMARY

Driver APIs (e.g., graphics) may capture an application's commands to an accelerator, or a graphics processing unit (GPU), for deterministic replay and debuggability.

When replaying captured command streams, a large block of assets may be loaded at the time that replay starts in order to restore the state of the memory/objects, prior to replaying the commands recorded for captured frames. To replay correctly, a full capture may be replayed from beginning to end. These assets may be captured in a separate file referred to as an asset database (DB). Any commands that construct/allocate new memory/objects or perform data modifications (e.g., memcpy, shader write back, etc.) may be replayed, reproducing the same results as those generated during capture (assuming a same hardware/graphics driver).

One issue with the above approach is that when loading the asset block and replaying a captured frame from the middle of a captured command stream, the state may not contain data modifications produced from frames before the replayed frame in the captured command stream. For example, replaying a second frame from the trace would not contain modifications from a first frame.

This problem is due to more explicit API protocol languages in which a driver is not as free to make runtime decisions. The granular nature of the commands may introduce replay problems since information is not stored locally in the API driver, and is instead expected to be stored at the application.

To overcome these issues, systems and methods are described herein that improve replay in explicit API languages. This functionality may be used in any trace capture tooling having a reusable asset. Index capture files may create key frame loading points in a trace that typically requires restarting from the beginning for proper fidelity. A system may be designed allowing for the rapid replay of traces from a point in the trace (e.g., random access or frame seeking without full replay).

Embodiments of the disclosure relate to the generation of the separate capture index file. This file may be generated during a post capture replay process (e.g., during frame buffer attachment collection). During replay of the capture file, initial asset data is loaded from the capture file, initializing the state of the graphics memory. The initial asset data may include all necessary assets (e.g., textures, shaders, buffers) required to ensure the replay begins with the appropriate context for accurate reproduction of captured frames. When the capture index file is present (after being generated in an offline fashion), the replay may perform a seek operation to the index file closest to and before the frame to replay. This allows for data compression and rendered frame random access, reducing the time to replay a frame from a random access point.

In an embodiment, a method is provided in which a processor generates an API capture file by recording commands provided from a central processing unit (CPU) to an accelerator. The API capture file includes asset data and a first set of frames having the commands. The processor determines delta changes generated by one or more frames in the first set of frames. The processor generates a capture index file including a second set of frames. Each frame of the second set of frames includes a delta change generated by a corresponding frame of the one or more frames in the first set of frames.

In an embodiment, a method is provided in which a processor determines a replay frame in a first set of frames of an API capture file. The API capture file includes a first set of frames having commands provided from a CPU to an accelerator. At least one delta change from at least one frame of a second set of frames of a capture index file is loaded to a memory accessible by the accelerator. Each frame of the second set of frames includes a delta change generated by a corresponding frame in the first set of frames. The at least one frame corresponds to at least one corresponding frame before the replay frame in the first set of frames. The replay frame in the first set of frames is replayed by the memory.

In an embodiment, a user equipment (UE) is provided that includes a processor and a non-transitory computer readable storage medium storing instructions. When executed, the instructions cause the processor to generate an API capture file by recording commands provided from a CPU to an accelerator. The API capture file includes asset data and a first set of frames having the commands. The instructions also cause the processor to determine delta changes generated by one or more frames in the first set of frames, and generate a capture index file including a second set of frames. Each frame of the second set of frames includes a delta change generated by a corresponding frame of the one or more frames in the first set of frames.

In an embodiment, a UE is provided that includes a processor and a non-transitory computer readable storage medium storing instructions. When executed, the instructions cause the processor to determine a replay frame in a first set of frames of an API capture file. The API capture file includes a first set of frames having commands provided from a CPU to an accelerator. The instructions also cause the processor to load, to a memory accessible by the accelerator, at least one delta change from at least one frame of a second set of frames of a capture index file. Each frame of the second set of frames includes a delta change generated by a corresponding frame in the first set of frames. The at least one frame corresponds to at least one corresponding frame before the replay frame in the first set of frames. The instructions further cause the processor to replay the replay frame in the first set of frames by the memory.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an electronic device, according to an embodiment;

FIG. 2 is a diagram illustrating an API capture file, according to an embodiment;

FIG. 3 is a diagram illustrating generation of a capture index file, according to an embodiment;

FIG. 4 is a diagram illustrating capture file frame replay using a capture index file, according to an embodiment;

FIG. 5 is a flowchart illustrating a method for performing trace replay, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

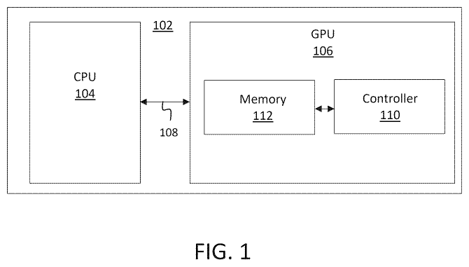

FIG. 1 is a diagram illustrating an electronic device, according to an embodiment. An electronic device (or UE) 102 may include a CPU 104 and an accelerator, such as a GPU 106, joined by a memory bus 108. The GPU 106 may include a controller 110 (e.g., computational engines and processors) and a memory 112. The memory 112 may include a common on-chip fixed sized memory (referred to as a local data store (LDS) memory) and/or a cache. The accelerator may also be embodied as a neural processing unit (NPU) or digital signal processor (DSP).

A set of API commands may be provided from the CPU 104 to the accelerator and may be recorded using an API-interception tracing software tool. With respect to the GPU 106, an API capture trace may be the resulting data file that includes all data and commands required to replay the recording over a time duration. This tracing tool may capture all assets (e.g., images, textures, shaders, vertices, and meta data) that correspond to the creation of the desired output. These assets may be front-loaded in the application to be made available for the rest of the commands to reference and use. Replaying the recording may entail loading the recorded data, initializing a state of the environment to match conditions of the original recording, executing recorded commands sequentially in the same order as they were issued during the original session, and processing the commands and front-loaded assets (by the GPU) to produce the same or similar output as during the original run.

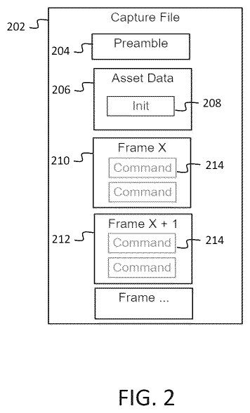

FIG. 2 is a diagram illustrating an API capture file, according to an embodiment. API captures may begin at an application start time and the assets may be stored in a separate file with an appropriate data structure (e.g., database, tree, or hash), which may be built from scratch for each new application that is run. Such applications use GPU-accelerated APIs, depend on large sets of assets, and a require detailed tracking of CPU-GPU interactions (e.g., graphics-intensive applications, simulation and visualization applications, machine learning/data processing pipelines).

Capture services may generate a single capture file 202 having a file header or preamble 204, which defines versions and device information. The preamble 204 may be followed by an asset data block 206 having initialization data 208. The asset data block 206 may be followed by N frames starting at a first frame X 210, a second frame X+1 212, and ending at frame X+N. Each frame (e.g., the first frame X 210, the second frame X+1 212) may include command streams 214. A command stream may be a sequence of API commands that are issued by the CPU to the GPU during execution of a frame or computational task. Specifically, a command stream may have instructions required to drive the GPU. If X=1, the asset data block 206 may be excluded, and data may be included in the command streams 214 of the captured frame. If X>1, the asset data block 206 may be generated to include all asset creation commands prior to the first frame X 210.

FIG. 2 does not provide a summary of delta changes generated by each frame embedded in the capture file 202. Specifically, a delta change may be an incremental difference or modification in the data and the GPU state between successive frames or commands within an API capture. Such delta changes represent what has been altered since a last recorded frame or command sequence. Delta changes are hardware/driver dependent and may not be consistent when replaying on a device that is different from that which performed the capture services. Delta changes may involve duplicating all of the data required to reproduce the commands in the stream, which may significantly bloat the capture files. In some instances, integrating applications may be required to replay the full capture multiple times in order to pull information such as, for example, frame buffer attachments, descriptor sets, vertex input attributes, etc. If an integrating application requires such information from a frame far into the capture file, this may be prohibitively time consuming. Earlier frames may only be played to generate the delta changes and to ensure data integrity of the replay of a desired frame.

According to an embodiment, a system may be designed allowing for the rapid replay of traces from a point in the trace without having to start the trace from the beginning (e.g., random access or frame seeking without full replay).

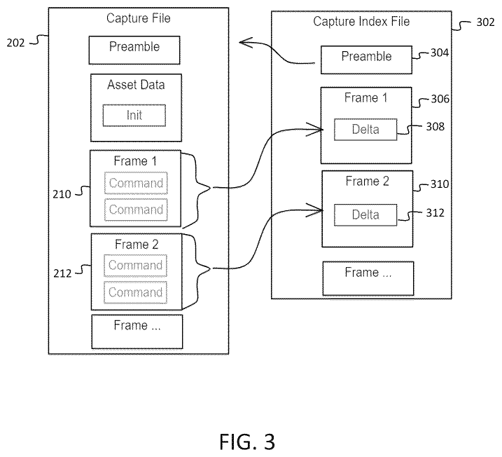

FIG. 3 is a diagram illustrating generation of a capture index file, according to an embodiment. A capture index file 302 may be generated during a post capture replay process (e.g., during frame buffer attachment collection). The capture index file 302 may be left on the replay hardware components or systems designed to replay recorded execution sequences, or stored on a host machine with the capture file 202. The capture index file 302 may include a preamble 304 having a reference to the capture file 202 and information about the device it was generated from. Such information may describe the hardware and software environment in which an index file was created (e.g., GPU model, CPU model, device architecture, memory configuration, bus type and speed, operating system, driver version, API version, screen resolution). The capture index file 302 may include frames with delta change blocks that record graphics memory/object changes that occurred during the playback of that frame on the current device. To record such changes, the delta changes between a current frame and a previous frame may first be identified and then stored in a block of delta changes. For example, a first frame 306 of the capture index file 302 may include a first delta change block 308 that records changes that occurred during playback of the first frame (e.g., the first frame X 210) of the capture file 202. A second frame 310 of the capture index file 302 may include a second delta change block 312 that records changes that occurred during playback of the second frame (e.g., the second frame X+1 212) of the capture file 202.

In some embodiments, the index file 302 is generated at the time of capture. In other embodiments, the index file 302 is generated as a post processing step, such as when ...By not generating the capture index file 302 at the time of capture, unnecessary overhead may be prevented during original capture. Generating the capture index file 302 as a post process may allow for the generation of accurate hardware/driver delta changes.

Accordingly, after the API capture trace is collected, the trace file may be post-processed to provide delta updates to the asset file in regular intervals (frame boundaries) so that a trace doesn't have to be run from start to end to obtain the proper state at a random frame between frame beginning and frame end. These key frame updates to the asset file may be of different varieties including full asset copies (e.g., all of the assets duplicated in whole), relative asset delta patches (e.g., only changed or added assets from a previous key frame update), which require many asset file updates to be chained together to get proper state, and absolute asset delta copy, which provide all changes from the last full asset copy. These key frame varieties may be intermixed based on use case to allow for speed of replay versus compression of data for outgoing traces or portability of trimmed traces. Trimmed traces from frame subX to subY may be created by squashing or combining delta state updates into the main full asset copy in an export process.

Performing a seek operation to frames or draws in a trace may be sped up by fast-forwarding to the key frame prior to the frame of interest, updating the assets into a fully resolved state, and continuing playback. Shortcuts may be made to only partially resolve assets if output data quality is secondary to replay speed.

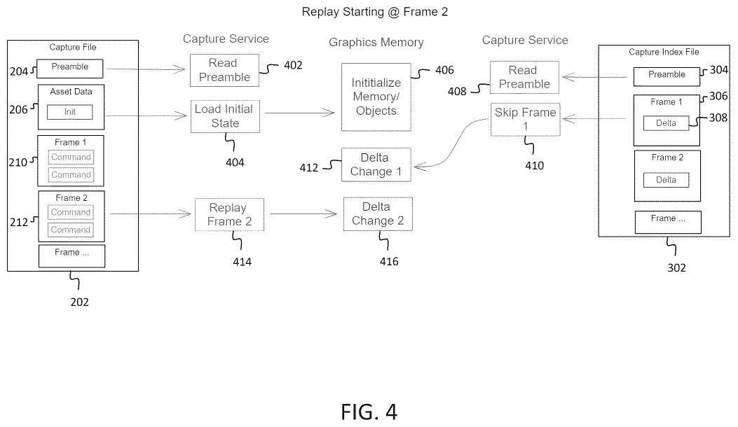

FIG. 4 is a diagram illustrating capture file frame replay using a capture index file, according to an embodiment. During replay of the capture file 202, the preamble 204 may be read at 402, and the initial asset data 206 may be loaded from the capture file 202 at 404, initializing the state of the graphics memory at 406. If a capture index file and a replay frame number are specified, the capture index file 302 may be loaded and the preamble 304 may be read to enable delta change loading and frame replaying, at 408. The preamble 304 may also be validated against the replay conditions (e.g., same capture file, same hardware profile). For each frame prior to the specified replay frame, the capture index file 302 may skip the frame by loading the delta change block from the capture index file 302 at the graphics memory. For example, in order to replay the second frame 212 of the capture file 202, the first frame 210 is skipped at 410 by loading the delta change block 308 of the first frame 306 from the capture index file 302 to the graphics memory at 412. The second frame 212 of the capture file 202 may then be replayed at 414 and the corresponding delta change is loaded at the graphics memory at 416.

If the preamble 304 of the capture index file 302 does not match the current replay device, a new capture index file may be created. The replay service may notify the user or integrating application that a new capture index file is required and that replay will proceed from the first frame of the capture file. The replay service may also provide an option to ignore loading of delta data from a missing or invalid capture index file, with the understanding that the data validity of the frame will not match the original run of the captured application. This may result in application instability if the delta change blocks contain new memory/object allocations.

According to another embodiment, points in the capture file may be automatically chosen where there are sufficient changes in the capture index file to require creation of a new capture index file. Such a method may involve heuristics. For example, using a state difference heuristic, some threshold percent of differences (e.g., 20%) in the state (e.g., GPU resource state, pipeline configuration, or asset modification) compared to the previous frame may automatically trigger the creation of a new capture index file. This threshold may be calculated by evaluation the ratio of modified elements (e.g., textures, buffers, shaders) to the total number of tracked elements within a frame. Regular intervals may involve fixed time steps or frame counts (e.g., every 100 frames), while non-regular intervals may depend on detected changes exceeding the defined threshold or significant events in the trace, such as a level load or a scene transition. A trigger for creating a new capture index file may include surpassing the threshold for resource changes, detecting a significant spike in command stream complexity, or identifying an abrupt increase in memory allocation or API calls. In some embodiments, the differences in state for the heuristic may be set at a low value (e.g., 5-10%) to ensure differences remain small and allow for efficient loading of the capture index file, even if skipping intermittent frames introduces minor variations in output.

Index frames of the capture index file may be regularly saved during a trace run. For example, every Y frames, an index frame may be created to improve the initial playback of non-regular requests for relay of a new frame. For example, an index file may be created for every tenth frame. If a frame replay on frame 27 is requested, a seek operation may be performed to frame 20 before replaying 7 frames (i.e., frames 21-27) are replayed. Additionally or alternatively, index frames may be saved in response to one or more triggers, such as based on a number of index files created or based on the state difference heuristic used to determine whether to create a capture index file.

The different kinds of index frames (e.g., full index frames, relative index frames, and absolute index frames) may be interchanged dynamically within a trace based on heuristics or regular patterns. For example a trace may begin with a full index frame to establish the complete state, followed by a series of relative index frames that capture incremental changes, and periodically include absolute index frames to re-anchor the trace and reduce cumulative error. Heuristics may dictate the selection of index frame types based on metrics such as the frequency or magnitude of state changes, the complexity of the command stream, or resource utilization thresholds. Regular patterns may alternate frame types at predefined intervals (e.g., a full index frame every 100 frames, with relative index frames in between) to balance accuracy and efficiency. This approach ensures flexibility in adapting the trace to the application's characteristics while maintaining a manageable file size and enabling efficient replay.

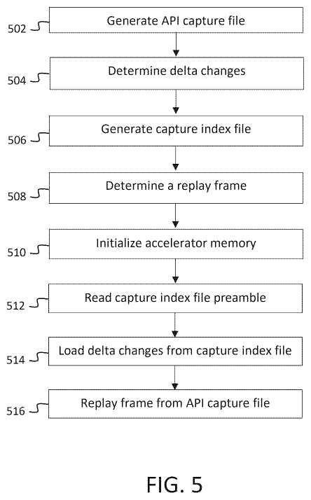

FIG. 5 is a flowchart illustrating a method for performing trace replay, according to an embodiment. At 502, an API capture file may be generated by recording commands provided from a CPU to an accelerator. The API capture file may include a first preamble, asset data, and a first set of frames having the commands. The asset data may include at least one of images, textures, shaders, vertices, or metadata for application output. At 504, a processor may determine delta changes generated by one or more frames in the first set of frames.

At 506, the processor generates a capture index file including a second set of frames. Each frame of the second set of frames includes a delta change generated by a corresponding frame of the one or more frames in the first set of frames. The capture index file may further include a second preamble. The corresponding frame of the first set of frames may be determined based on an amount of change generated by the corresponding frame, or based on an interval between frames in the first set of frames. Each frame in the second set of frames may be one of a full index frame having asset data, a relative index frame with intermediate changes from a previous frame, or an absolute index frame indicating difference from the asset data.

At 508, the processor may determine a replay frame in the first set of frames. At 510, the processor may initialize a memory of the accelerator based on the first preamble and the asset data. At 512, the second preamble may be read to enable loading of at least one delta change and replaying of the replay frame. The second preamble may also be read for validation based on the API capture file and/or a hardware profile.

At 514, at least one delta change from at least one frame of the second set of frames may be loaded to the memory. The at least one frame corresponds to at least one corresponding frame before the replay frame in the first set of frames. Loading the at least one delta change may include skipping replay in the first set of frames up to a last of the at least one corresponding frame before the replay frame.

At 516, the replay frame in the first set of frames may be replayed by the memory.

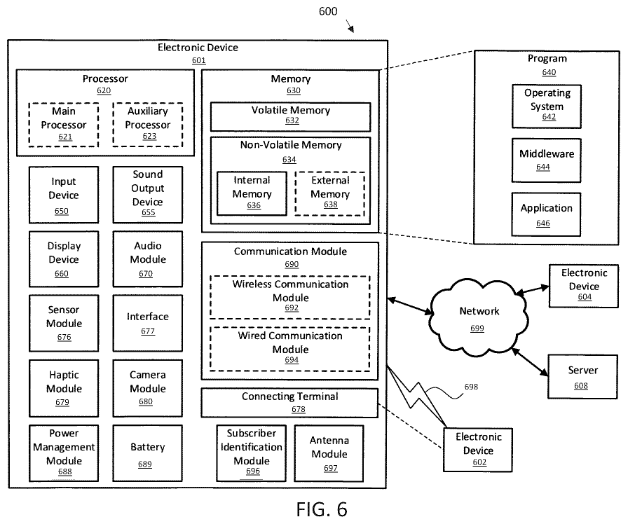

FIG. 6 is a block diagram of an electronic device in a network environment 600, according to an embodiment.

Referring to FIG. 6, an electronic device (or UE) 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
generating, by a processor, an application programming interface (API) capture file by recording commands provided from a central processing unit (CPU) to an accelerator, wherein the API capture file comprises asset data and a first set of frames having the commands;
determining, by the processor, delta changes generated by one or more frames in the first set of frames; and
generating, by the processor, a capture index file comprising a second set of frames, wherein each frame of the second set of frames comprises a delta change generated by a corresponding frame of the one or more frames in the first set of frames.

2. The method of claim 1, wherein the asset data comprises at least one of images, textures, shaders, vertices, or metadata for application output.

3. The method of claim 1, wherein the API capture file further comprises a first preamble, and the capture index file further comprises a second preamble.

4. The method of claim 3, further comprising:
determining, by the processor, a replay frame in the first set of frames;
initializing, by the processor, a memory of the accelerator based on the first preamble and the asset data;
loading, to the memory, at least one delta change from at least one frame of the second set of frames, wherein the at least one frame corresponds to at least one corresponding frame before the replay frame in the first set of frames; and
replaying the replay frame in the first set of frames by the memory.

5. The method of claim 4, further comprising:
reading the second preamble to enable the loading of the at least one delta change and the replaying of the replay frame, or for validation based on at least one of the API capture file or a hardware profile.

6. The method of claim 4, wherein loading the at least one delta change comprises skipping replay in the first set of frames up to a last of the at least one corresponding frame before the replay frame.

7. The method of claim 1, wherein generating the capture index file comprises:
determining, by the processor, the corresponding frame of the first set of frames based on an amount of change generated by the corresponding frame; or
determining, by the processor, the corresponding frame of the first set of frames based on an interval between frames in the first set of frames.

8. The method of claim 1, wherein each frame of the second set of frames comprises a full index frame comprising the asset data, a relative index frame comprising intermediate changes from a previous frame in the second set of frames, or an absolute index frame indicating differences from the asset data.

9. A method comprising:
determining, by a processor, a replay frame in a first set of frames of an application programing interface (API) capture file, wherein the API capture file comprises a first set of frames having commands provided from a central processing unit (CPU) to an accelerator;
loading, to a memory accessible by the accelerator, at least one delta change from at least one frame of a second set of frames of a capture index file, wherein each frame of the second set of frames comprises a delta change generated by a corresponding frame in the first set of frames, and wherein the at least one frame corresponds to at least one corresponding frame before the replay frame in the first set of frames; and
replaying the replay frame in the first set of frames by the memory.

10. The method of claim 9, wherein the API capture file further comprises a first preamble and asset data, and the capture index file further comprises a second preamble.

11. The method of claim 10, further comprising:
initializing, by the processor, the memory of the accelerator based on the first preamble and the asset data.

12. The method of claim 10, further comprising:
reading the second preamble to enable the loading of the at least one delta change and the replaying of the replay frame, or for validation based on at least one of the API capture file or a hardware profile.

13. The method of claim 9, wherein loading the at least one delta change comprises skipping replay in the first set of frames up to a last of the at least one corresponding frame before the replay frame.

14. A user equipment (UE) comprising:
a processor; and
a non-transitory computer readable storage medium storing instructions that, when executed, cause the processor to:
generate an application programming interface (API) capture file by recording commands provided from a central processing unit (CPU) to an accelerator, wherein the API capture file comprises asset data and a first set of frames having the commands;
determine delta changes generated by one or more frames in the first set of frames; and
generate a capture index file comprising a second set of frames, wherein each frame of the second set of frames comprises a delta change generated by a corresponding frame of the one or more frames in the first set of frames.

15. The UE of claim 14, wherein the API capture file further comprises a first preamble, and the capture index file further comprises a second preamble.

16. The UE of claim 14, wherein, in generating the capture index file, the instructions further cause the processor to:
determine the corresponding frame of the first set of frames based on an amount of change generated by the corresponding frame; or
determine the corresponding frame of the first set of frames based on an interval between frames in the first set of frames.

17. The UE of claim 14, wherein each frame of the second set of frames comprises a full index frame comprising the asset data, a relative index frame comprising intermediate changes from a previous frame in the second set of frames, or an absolute index frame indicating differences from the asset data.

18. A user equipment (UE) comprising:
a processor; and
a non-transitory computer readable storage medium storing instructions that, when executed, cause the processor to:
determine a replay frame in a first set of frames of an application programing interface (API) capture file, wherein the API capture file comprises a first set of frames having commands provided from a central processing unit (CPU) to an accelerator;
load, to a memory accessible by the accelerator, at least one delta change from at least one frame of a second set of frames of a capture index file, wherein each frame of the second set of frames comprises a delta change generated by a corresponding frame in the first set of frames, and wherein the at least one frame corresponds to at least one corresponding frame before the replay frame in the first set of frames; and
replay the replay frame in the first set of frames by the memory.

19. The UE of claim 18, wherein:
the API capture file further comprises a first preamble and asset data, and the capture index file further comprises a second preamble; and
the instructions further cause the processor to:
initialize the memory of the accelerator based on the first preamble and the asset data; and
read the second preamble to enable the loading of the at least one delta change and the replaying of the replay frame, or for validation based on at least one of the API capture file or a hardware profile.

20. The UE of claim 18, wherein, in loading the at least one delta change, the instructions further cause the processor to skip replay in the first set of frames up to a last of the at least one corresponding frame before the replay frame.
